(19) United States
(12) Patent Application Publication
(10) Pub. No.: US 2026/0138345 A1
(43) Pub. Date: May 21, 2026

(54) HYDRAULIC PULP BALE PRESS FOR COMPRESSING PULP BALES AND METHOD OF COMPRESSING

(71) Applicant: VALMET AB, Sundsvall (SE)

(72) Inventors: Stefan NORDHÄLLING, Ankarsvik (SE); Tobias LÖÖF, Söråker (SE); Jonas BYLUND, Timrå (SE)

(73) Assignee: VALMET AB, Sundsvall (SE)

(21) Appl. No.: 19/119,213

(22) PCT Filed: Sep. 26, 2023
(86) PCT No.: PCT/SE2023/050939

§ 371 Date: Apr. 8, 2025

(30) Foreign Application Priority Data
Nov. 24, 2022 (SE) 2230383-8

(51) Int. Cl. B30B 9/30

(52) U.S. Cl. CPC B30B 9/3057

(57) ABSTRACT

A pulp bale press for compressing pulp bales and configured for use in a pulp bale production line includes: a base; a top positioned opposite the base and connected to the base; and a movable pressing element configured to move between the base and the top. The pulp bale press is configured to compress a first pulp bale to be compressed between the base and the movable pressing element and to compress a second pulp bale to be compressed between the top and the movable pressing element. The movable pressing element is movably attached to the base via a first plurality of hydraulic cylinders comprising at least two hydraulic cylinders. The movable pressing element is movably attached to the top via a second plurality of hydraulic cylinders comprising an equal number of hydraulic cylinders as the first plurality of hydraulic cylinders.

The present patent disclosure concerns a hydraulic pulp baling press, a method of pulp bale pressing and a pulp bale production line or system.

Pulp is a material prepared by chemical or mechanical means from various materials, such as wood or rags, for use in, among others, making paper and cellulose products. Pulp comprises lignocellulosic fibers and can be used for producing paper. When pulp is produced, it can either be directly used in paper production on-site, or pulp can be packaged for shipment to produce paper elsewhere.

Often, the pulp is formed into sheets which are cut and stacked into bales. To reduce the volume of the fluffy pulp, the bales are compressed in a pulp bale press to reduce the volume of the pulp bales and thereafter packaged for shipment. As pulp production is typically a continuous process, the pulp bale press is part of the pulp production line. In a production line, the number of pulp bales to be compressed by the press may be, for instance, as high as 300 pulp bales per hour.

A pulp bale press may comprise a base comprising a conveyor, such as a conveyor belt, which positions the incoming pulp bale to be compressed below a movable pressing element or ram. Once the pulp bale to be compressed is in position, the movable pressing element is pushed downwards towards the base to compress the pulp bale with a certain force, for instance 15,000 kN. This force is, for instance, suitable for a pulp bale weighing 250 kg. The downwards force of the movable pressing element is usually applied using a hydraulic cylinder arranged above the movable pressing element. Often a single, relatively large, hydraulic cylinder is used in order to apply the above noted force. The hydraulic pump and other hydraulic parts are positioned near the top of the bale press, close to the hydraulic cylinder, to avoid pressure drop and reduce the volume of hydraulic fluid. This high position causes an increased noise load in the vicinity of the press, which is unwanted. Service and maintenance are furthermore complicated and thus expensive.

Once the movable pressing element is at a point where the required force is applied, it will have to be lifted back upwards. This upward movement includes retracting the large hydraulic cylinder using additional smaller cylinders, often referred to as pre-pressing cylinders. In addition, one or more slave cylinders are employed which help to take out the hydraulic oil from the large hydraulic cylinder. In addition, the compressed bale is output of the pulp pale press and thereafter a new, not yet compressed and thus higher, pulp bale to be compressed is input into the pulp bale press. These necessary steps set a boundary for the number of pulp bales to be compressed by these pulp bale presses. An example of such a pulp bale press is the Valmet RoboPress PR-15.

It is an object, among objects, to provide an improved pulp bale press.

To this end, a pulp bale press for compressing pulp bales is provided, comprising; a base; a top positioned opposite the base and connected to the base; and a movable pressing element configured to move between the base and the top, wherein the pulp bale press is configured to compress a first pulp bale to be compressed between the base and the movable pressing element and to compress a second pulp bale to be compressed between the top and the movable pressing element, the movable pressing element is movably attached to the base via a first plurality of hydraulic cylinders comprising at least two hydraulic cylinders, and the movable pressing element is movably attached to the top via a second plurality of hydraulic cylinders comprising an equal number of hydraulic cylinders as the first plurality of hydraulic cylinders.

The use of multiple hydraulic cylinders allows the size of each cylinder to be reduced. In addition, the cylinders may have similar or identical hydraulic volumes. This makes maintenance more effective, efficient, and less costly. In addition, the hydraulic pump can be placed on ground or floor level or lower so that the amount of noise experienced by workers in the space where the press is located is reduced. This is in particular the case when the hydraulic cylinders are placed laterally onto the press, holding the movable pressing element. The hydraulic cylinders together supply the total force required.

To aid the lifting upwards of the movable pressing element of presses having less (e.g. a single) and thus larger hydraulic cylinders additional hydraulic cylinders such as pre-pressing cylinders and slave cylinders are employed, as described above. These additional hydraulic cylinders require, among others, hydraulic connections, pumps, valves and additional hydraulic oil, and thus increase the number of parts and complexity of the hydraulic system. By using the multiple hydraulic cylinders, as in the presses according to the present patent disclosure, this problem is resolved, since for the moving up and down of the movable pressing element when no or a low force is applied, a number of hydraulic cylinders of the first and/or second pluralities of hydraulic cylinders less than the total number of hydraulic cylinders can be used.

In this pulp bale press, furthermore, since the movable pressing element presses a pulp bale both in a downward direction and thereafter in an upward direction, the number of pulp bales produced per unit of time is greatly increased. In practice, an increased output compared to the single bale press of about 140% can be achieved.

In an embodiment, the pulp bale press is configured for use in a pulp production line. The pulp bale having an increased number of pulp bales produced per unit of time is particularly useful when used in a pulp production line, such that the production output is enhanced.

In an embodiment, the base comprises a first pressing surface, the movable pressing element comprises a second pressing surface facing the first pressing surface and a third pressing surface facing the top, the top comprises a fourth pressing surface facing the third pressing surface, and the pulp bale press is configured to receive the first bale to be compressed between the first pressing surface and the second pressing surface, compress the first bale by movement of the movable pressing element towards the base, receive the second bale to be compressed between the third pressing surface and the fourth pressing surface, and compress the second bale by movement of the movable pressing element towards the top. The first and second pressing surfaces may be substantially parallel and the third and fourth pressing surfaces may be substantially parallel.

In an embodiment, the first plurality of hydraulic cylinders comprises an even number of hydraulic cylinders, and the second plurality of hydraulic cylinders comprises an even number of hydraulic cylinders. The hydraulic cylinders of each the first and second pluralities of hydraulic cylinders are equally divided over two lateral sides of the pulp bale press. This provides for a stable press structure by having a generally equal amount of force on each side of the movable pressing element.

The first plurality of hydraulic cylinders may have a total first volume and the second plurality of hydraulic cylinders may have a total second volume, wherein the total first volume may be substantially equal to the total second volume. In this way, the hydraulic fluid used by each hydraulic cylinder is equal.

In an embodiment, the first plurality of hydraulic cylinders comprises at least four hydraulic cylinders and the second plurality of hydraulic cylinders comprises an equal number of hydraulic cylinders as the first plurality of hydraulic cylinders. The first plurality of hydraulic cylinders may, for instance, comprise six hydraulic cylinders.

In an embodiment, the first plurality of hydraulic cylinders comprises at least two hydraulic cylinders and the second plurality of hydraulic cylinders comprises an equal number of hydraulic cylinders as the first plurality of hydraulic cylinders.

The bale press may comprise a hydraulic system supplying hydraulic fluid to the first and second pluralities of hydraulic cylinders. The hydraulic system may comprise a pump hydraulically connected to the first and second pluralities of hydraulic cylinders, a hydraulic fluid reservoir hydraulically connected to the pump and valves configured to selectably supply hydraulic fluid to the one or more of the first and second pluralities of hydraulic cylinders. The one or more controllers may be configured to control the hydraulic system. The hydraulic system may alternatively comprise one or more hydraulics controllers comprised in the one or more controllers.

The first plurality and second plurality of hydraulic cylinders may be hydraulically connected via one or more valves, such as the valves mentioned above. Each of the hydraulic cylinders may comprise a cylinder barrel and a piston which is movably arranged. The piston comprises a piston rod extending from the cylinder barrel. The barrel may be closed on one end by the cylinder end (or bottom or cap) and at the other end by a cylinder head out from which the piston head extends. The hydraulic cylinders each comprise a first hydraulic fluid chamber and a second hydraulic fluid chamber, the first hydraulic fluid chamber being in the barrel between the piston and the cylinder end and the second hydraulic fluid chamber being in the barrel between the piston and the cylinder head. Each of the hydraulic cylinders may comprise a first hydraulic fluid port for allow hydraulic fluid to flow into and out of the first hydraulic fluid chamber. Each of the hydraulic cylinders may comprise a second hydraulic fluid port for allowing hydraulic fluid to flow into and out of the second hydraulic fluid chamber.

In order to push the piston rod in an outward direction relative to the barrel, the (pressurized) hydraulic fluid is input into the first hydraulic fluid chamber. It will be apparent that the first hydraulic fluid chamber then increases in size, and that the second hydraulic fluid chamber reduces in size. In order to push back the piston rod into the barrel, the (pressurized) hydraulic fluid is input into the second hydraulic fluid chamber. Now, the first hydraulic fluid chamber reduces in size, and the second hydraulic fluid chamber increases in size.

The movable pressing element may be attached to outer ends of the respective piston rods of the hydraulic cylinders of the first and second plurality of hydraulic cylinders. The respective barrels of the first plurality of hydraulic cylinders are connected to the base of the bale press. The respective barrels of the second plurality of hydraulic cylinders are connected to the top of the bale press. By extending and contracting the piston rods, the movable pressing element is moved from and towards the top (i.e. towards and from the base respectively). It will be understood that the movable pressing element could alternatively be attached to the barrels of the hydraulic cylinders instead of the piston rods.

The bale press may be configured such that first respective one or more hydraulic cylinders of the first plurality of hydraulic cylinders is controllably hydraulically connected to second respective one or more hydraulic cylinders of the second plurality of hydraulic cylinders such that hydraulic fluid flowing out of the first respective one or more hydraulic cylinders flows into the second one or more hydraulic cylinders, and that hydraulic fluid flowing out of the second respective one or more hydraulic cylinders flows into the first one or more hydraulic cylinders. It will be understood that two hydraulic cylinders would be connected such that fluid flowing from the first hydraulic fluid chamber of one hydraulic cylinder (which thus contracts its piston rod) can flow towards the first hydraulic fluid chamber of the other hydraulic cylinder (which thus extends its piston rod), and fluid flowing from the second hydraulic fluid chamber of one hydraulic cylinder (which thus extends its piston rod) can flow towards the second hydraulic fluid chamber of the other hydraulic cylinder (which thus contracts its piston rod). The controllable hydraulic connection can be achieved by using one or more controllable valves, which may be a preferred embodiment of the above-mentioned valves. These valves can be controlled by the one or more controllers. The above can be seen as a hydraulic “short circuiting” mode, or free moving state or mode, of selected number of hydraulic cylinders so that they move freely.

In view of the above, beneficially, the volume of required hydraulic oil can be reduced. Also, there is no or less need to use the additional pre-pressing cylinders as described above, because a reduced number of hydraulic cylinders can be used, for instance when not compressing pulp bales but moving the movable pressing element, while the other hydraulic cylinders are moving freely.

In an embodiment, the movable pressing element is configured to receive the second bale along a first axis thereof; the movable pressing element comprises first and second lateral sides extending parallel to the first axis; an equal number of the first plurality of hydraulic cylinders is attached the movable pressing element to each of the first and second lateral sides; and an equal number of the second plurality of hydraulic cylinders is attached the movable pressing element to each of the first and the second lateral sides.

In a further embodiment, the first plurality of hydraulic cylinders has a total first volume and the second plurality of hydraulic cylinders has a total second volume, wherein the total first volume is substantially equal to the total second volume.

In another embodiment, the pulp bale press comprising one or more controllers configured to control the movement of the movable pressing element.

In yet another embodiment, the one or more controllers are configured to control hydraulic fluid flow towards and from the first plurality of hydraulic cylinders and the second plurality of hydraulic cylinders in order to control the movement of the movable pressing element.

In another embodiment, the pulp bale press further comprises a hydraulic pump, which may be an embodiment of the hydraulic pump mentioned above, wherein the hydraulic pump is hydraulically connected to the first plurality of hydraulic cylinders and the second plurality of hydraulic cylinders, wherein the one or more controllers are configured to control the hydraulic pump such that the movement of the movable pressing element is controlled.

In a further embodiment, the hydraulic pump is configured to supply pressurized hydraulic fluid to a first hydraulic fluid branch causing one or more of the hydraulic cylinders of the first and second pluralities of hydraulic cylinders to move the movable pressing element towards the base and to a second hydraulic fluid branch causing one or more hydraulic cylinders of the first and second pluralities of hydraulic cylinders to move the movable pressing element towards the top. The hydraulic pump may be a bidirectional hydraulic pump.

In an embodiment, one or more first subbranches of the first hydraulic fluid branch are hydraulically connectable to respective one or more second subbranches of the second hydraulic fluid branch via one or more hydraulic valves, which may be a preferred embodiment of the valves mentioned above, such that one or more hydraulic cylinders of the first and second pluralities of hydraulic cylinders are in a free moving state while the first or the second hydraulic fluid branch is pressurized. This is an embodiment of the above-mentioned short-circuiting mode or free moving state or mode of a selected number of hydraulic cylinders so that they move freely. In this way, using less hydraulic cylinders when the movable pressing element is moving without pressing a pulp bale, the movable pressing element can move faster, thus achieving a gain in pressing speed.

In a further embodiment, the movable pressing element is configured to receive the second bale along a first axis thereof; the movable pressing element comprises first and second lateral sides extending parallel to the first axis; wherein an equal number of the first plurality of hydraulic cylinders is attached the movable pressing element to each of the first and second lateral sides; and wherein an equal number of the second plurality of hydraulic cylinders is attached the movable pressing element to each of the first and the second lateral sides.

In yet another embodiment, the movable pressing element comprises a conveyor along the third pressing surface for positioning the second bale, wherein the conveyor may be a belt conveyor. The upper part of the conveyor belt comprises the third pressing surface. The conveyor is configured to allow for receiving an input bale from a first side, positioning the bale into a position in which in can be pressed against the top and thereafter output the bale to the other side of the press, opposite the first side. Beneficially, a belt conveyor, being flat, allows for compressing the bale while the bale is on the conveyor belt.

Optionally, the belt conveyor comprises two parallel belts that can be individually controlled such that the bale can also be rotated for positioning while on the movable pressing element. The movable pressing element may further comprise a pressing base to which the conveyor is attached at a top facing side thereof. The pressing base may comprise a solid portion configured for pressing the (upper and lower) bales. The solid portion is thus configured to apply the required pressing force towards the base and the top.

The conveyor belt may be implemented such that the belt slides along itself in two directions along the upper side of the movable pressing element.

In still another embodiment, the one or more controllers are configured to control the movement of the movable pressing element. Advantageously, the one or more controllers can automate the bale press so that the bale pressing speed of the bale press can be increased.

The one or more controllers may be configured to allow input of the second bale onto the movable pressing element when the movable pressing element is in a first position in which the top and the movable pressing element are sufficiently distanced to receive the second pulp bale to be compressed. Once an opening between the movable pressing element and the top is large enough, the second bale may be input.

The first position of the movable pressing element may be a position in which, when the first bale is present between the base and the movable pressing element, the first bale would be at least partially compressed. In this way, the number of bales compressed by the bale press is increased, since the feeding of the second bale is done during the compressing of the first bale. In an embodiment, the bale press may comprise a feeding mechanism configured for allowing the second bale to be fed while the movable pressing element is moving, for instance in a direction towards the base when pressing, or moving to press, the first bale.

In an embodiment, the top is connected to the base by one or more connecting elements, wherein the pulp bale press is configured such that the movable pressing element is guided along the one or more connecting elements. The connecting elements may be implemented as pillars or columns.

In yet another embodiment, the pulp bale press is configured to apply a force to the first bale and the second bale in the range of 2,000 to 40,000 kN (equal to about 200 to 4000 metric tons). The pulp bale press may, for example, be configured to apply a force to the first bale and the second bale in the range of 500 to 2,500 kN, such as 6,000, 7,000, 8,000, 9,000, 1,0000, 11,000, 12,000, 13,000, 14,000, 15,000, 16,000, 17,000, 18,000, 19,000, 20,000, 21,000, 22,000, 23,000, or 24,000 kN or any range therebetween. It will be understood that the size of the hydraulic cylinders is chosen depending on the wanted number of hydraulic cylinders and the above noted force ranges. For instance, when the first and second pluralities of hydraulic cylinders in total comprise twelve hydraulic cylinders, each hydraulic cylinder may be configured to apply one twelfth of any one of the above-mentioned forces and/or force ranges, when retracting and/or extending their respective piston rods.

It will be apparent that in the present disclosure concerning the bale press, the top is stationary relative to the base. The top may be attached to the base via fixing members, for instance embodied as four pillars or columns.

In general, an uncompressed pulp bale is a bundle of pulp. This may be a stack of pulp sheets. Often, a bale, when seen from the top, has a rectangular shape.

In an embodiment, the pulp bale press comprises an input aligning mechanism and an output aligning mechanism, wherein the input aligning mechanism is configured to input a pulp bale to be compressed onto the movable pressing element while the movable pressing element is moving, wherein the output aligning mechanism is configured to output a pulp bale to be compressed onto the movable pressing element while the movable pressing element is moving. In an embodiment, the pulp bale press comprises or is configured to work together with an input conveyor, wherein input aligning mechanism comprises an extendable arm and a complementary fork which have overlapping positions along the first axis when the extendable arm is in an extended position, wherein the input aligning mechanism is configured such that the movable pressing element receives a pulp bale to be compressed when moving upwards towards to the top when the extendable arm is in the extended position and a pulp bale is positioned within the overlapping positions along the first axis.

Alternatively, the pulp bale press comprises or is configured to work together with a rotatable pulp bale input conveyor configured to work, wherein a position of the movable pressing element facing edge of the rotatable pulp bale input conveyor is aligned with the rotatable input conveyor facing upper outer edge of the movable pressing element. In this case, the input aligning mechanism comprises the rotatable pulp bale input conveyor.

In this way, the pulp bales to be compressed can be fed onto movable pressing element while it is moving, thus increasing the compressed pulp bale output speed.

Similar configurations are provided for a rotatable pulp bale output conveyor, of which a position of the movable pressing element facing bale output edge of the rotatable output conveyor is aligned with the rotatable output conveyor facing upper outer edge of the movable pressing element.

According to a second aspect, there is provided a pulp bale production system or line configured to produce pulp bales from a cellulose containing raw material, the pulp bale production system comprising the pulp bale press according to the first aspect. Beneficially, when used in a pulp bale production system or line, the use of the faster pulp bale press allows for an increased output of compressed pulp bales.

According to a third aspect, there is provided a method of compressing pulp bales in a pulp bale press according to any one embodiment of the first aspect or the pulp bale production system or line according to the second aspect, the method comprising: inputting the first bale to be compressed between the base and the movable pressing element; compressing the first bale by moving the movable pressing element towards the base using the first plurality of hydraulic cylinders and the second plurality of hydraulic cylinders; when the movable pressing element has moved to a first position in which the top and the movable pressing element are sufficiently distanced to receive the second pulp bale, inputting the second bale to be compressed between the movable pressing element and the top; and compressing the second bale by moving the movable pressing element towards the top using the first plurality of hydraulic cylinders and the second plurality of hydraulic cylinders.

In an embodiment, the inputting the first bale comprises inputting the first bale between the first pressing surface and the second pressing surface; and the inputting the second bale comprises, when the movable pressing element has moved to a first position in which the third pressing surface and the fourth pressing surface are sufficiently distanced to receive a second pulp bale, inputting the second bale to be compressed onto the third pressing surface.

In another embodiment, the compressing the first bale by moving of the movable pressing element towards the base comprises: when the movable pressing element is distanced from the first bale, switching a first number of hydraulic cylinders of the first and second pluralities of hydraulic cylinders into a free moving state, wherein the first number of hydraulic cylinders is smaller than a total number of hydraulic cylinders of the first and second pluralities of hydraulic cylinders, wherein a first remainder of hydraulic cylinders of the first and second pluralities of hydraulic cylinders is actuated to move the movable pressing element; moving the movable pressing element towards the base to a first pressing position with respect to the first bale; switching the number of hydraulic cylinders from the free moving state to an actuated state; and compressing the first bale by moving the movable pressing element towards the base using all hydraulic cylinders of the first and second pluralities of hydraulic cylinders.

In yet another embodiment, the compressing the second bale by moving of the movable pressing element towards the top comprises: when the top is distanced from the second bale, switching a second number of hydraulic cylinders of the first and second pluralities of hydraulic cylinders into a free moving state, wherein the second number of hydraulic cylinders is smaller than a total number of hydraulic cylinders of the first and second pluralities of hydraulic cylinders, wherein a second remainder of hydraulic cylinders of the first and second pluralities of hydraulic cylinders is actuated to move the movable pressing element; moving the movable pressing element towards the top to a second pressing position with respect to the second bale; switching the second number of hydraulic cylinders from the free moving state to an actuated state; and compressing the second bale by moving the movable pressing element towards the top using all hydraulic cylinders of the first and second pluralities of hydraulic cylinders.

In an embodiment, the first pressing position may be reached when a force is to be applied to the first bale that is larger than a total force that the remainder of hydraulic cylinders are configured to apply; and/or the second pressing position is reached when a force is to be applied to the second bale that is larger than a total force that the remainder of hydraulic cylinders are configured to apply.

Additionally or alternatively, the first number of hydraulic cylinders is equal to the second number of hydraulic cylinders, wherein the first remainder of hydraulic cylinders is equal to the second remainder of hydraulic cylinders.

The method may more generally comprise inputting the first bale to be compressed between the base and the movable pressing element; compressing the first bale by moving the movable pressing element towards the base; when the movable pressing element has moved to a first position in which the top and the movable pressing element are sufficiently distanced to receive the second pulp bale, inputting the second bale to be compressed between the movable pressing element and the top; and compressing the second bale by moving the movable pressing element towards the top.

The pulp bale press used in the method may be a pulp bale press according to the first aspect or the method may be in a pulp bale production system as per the second aspect.

In an embodiment, the inputting the first bale comprises inputting the first bale between the first pressing surface and the second pressing surface; and the inputting the second bale comprises, when the movable pressing element has moved to a first position in which the third pressing surface and the fourth pressing surface are sufficiently distanced to receive a second pulp bale, inputting the second bale to be compressed onto the third pressing surface.

The method may further comprise, when the movable pressing element has moved to a second position in which the second pressing surface is not in contact with the compressed first pulp bale, outputting the compressed first bale from the first pressing surface.

In another embodiment, the method further comprises, when during or after outputting the compressed first bale from the first pressing surface the movable pressing element has moved to a third position in which the first pressing surface and the second pressing surface are sufficiently distanced to receive a third pulp bale to be compressed, inputting the third bale to be compressed between the first pressing surface and the second pressing surface.

In yet another embodiment, the method further comprises, when the movable pressing element has moved to a fourth position in which the fourth pressing surface is not in contact with the compressed second pulp bale, output the compressed second bale from the third pressing surface; and when during or after outputting the compressed second bale from the fourth pressing surface the movable pressing element has moved to a fourth position in which the third pressing surface and the fourth pressing surface are sufficiently distanced to receive a fourth pulp bale to be compressed, input the fourth bale to be compressed between the third pressing surface and the fourth pressing surface.

In still another embodiment, in the steps of inputting the first, second and third pulp bales the first, second and third pulp bales are input on respective input sides of the pulp bale press, wherein in the steps of outputting the first, second and third pulp bales the first, second and third pulp bales are output on respective output sides of the pulp bale press, wherein the input sides are opposite the corresponding output sides.

It will be understood that technical advantages and effects associated with features and/or embodiments of one aspect, apply to the corresponding, similar or equivalent features and/or embodiments the other aspects. It will also be apparent that the features of the various aspects and/or embodiments thereof may be applied to the other aspects and/or embodiments thereof.

### BRIEF DESCRIPTION OF THE DRAWINGS

The accompanying drawings are used to illustrate presently preferred non-limiting exemplary embodiments of devices of the present disclosure. The above and other advantages of the features and objects of the disclosure will become more apparent, and the aspects and embodiments will be better understood from the following detailed description when read in conjunction with the accompanying drawings, in which:

FIG. 1 illustrates a schematic perspective view of a pulp bale press according to an embodiment of the present patent disclosure;

FIG. 2 illustrates a schematic perspective view of a pulp bale press according to an embodiment of the present patent disclosure;

FIG. 3 illustrates a schematic cross section of the pulp bale press of FIG. 2, wherein the cross section is indicated in FIG. 2;

FIGS. 4A-4H illustrate respective schematic side views of the pulp bale press according to the present patent disclosure, showing the feeding in and out and pressing of pulp bales in the pulp bale press;

FIGS. 5A-5D illustrate respective schematic side views of a pulp bale press according to the present patent disclosure, showing a particular configuration of feeding in and out and pressing of pulp bales in the pulp bale press;

FIGS. 6A-6E illustrate respective schematic top of the movable pressing element and (parts of) the in-and output structure of the pulp bale press of FIGS. 5A-5D;

FIGS. 7A-7C illustrate respective sides views of a movable pressing element and in-and output structure for feeding in pulp bales onto the movable pressing element while it is moving;

FIG. 8 illustrates a scheme of a part of an embodiment of a hydraulic system for the pulp bale presses according to the present patent disclosure;

FIG. 9; illustrates a scheme of a part of another embodiment of a hydraulic system comprising controllable valves for the pulp bale presses according to the present patent disclosure; and

FIG. 10 illustrates a scheme of a part of yet another embodiment of a hydraulic system comprising controllable valves for the pulp bale presses according to the present patent disclosure.

### DETAILED DESCRIPTION OF PREFERRED EMBODIMENTS

Although the present invention has been described with reference to specific embodiments, also shown in the appended drawings, it will be apparent to those skilled in the art that many variations and modifications can be done within the scope of the invention as described in the specification and defined with reference to the claims below.

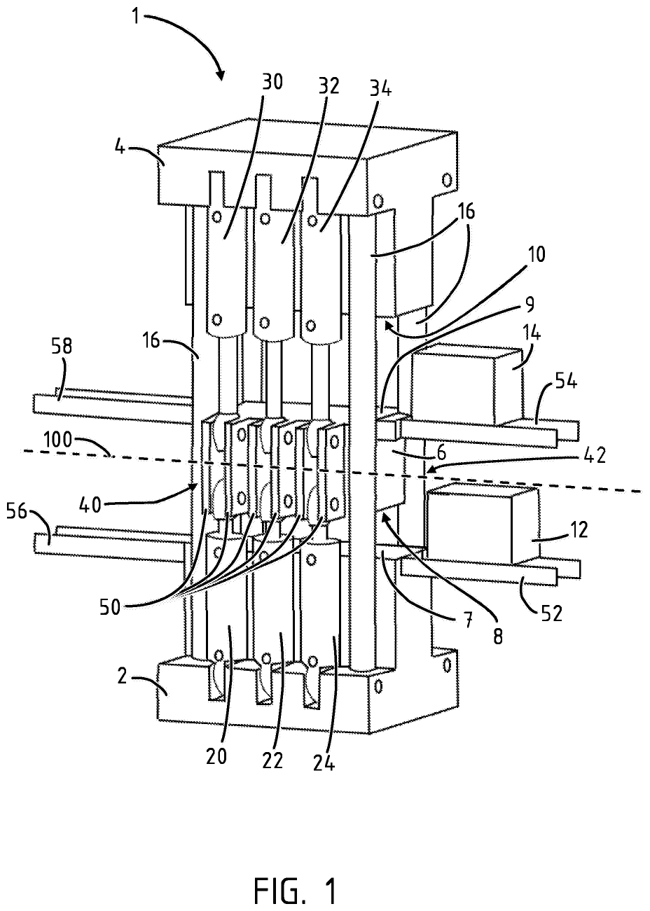

The bale press 1 comprises a base 2 which is connected to the top 4 via pillars or columns 16, which extend from the base to the top. The pillars or columns 16 are an embodiment of the one or more connecting elements. Between the pillars 16 are openings for in- and outputting the first pulp bale 12 and the second pulp bale 14. The bale press 1 comprises a movable pressing element 6, which is here embodied as ram 6. Alternatively, the ram can be referred to as a stamp. The ram 6 is movable arranged and is guided along the pillars 16, for instance using bearings. The ram 6 comprises a first lateral side 40 and a second lateral side 42 opposite the first lateral side, both lateral sides extending parallel to first axis 100. The ram 6 comprises a plurality of fastening portions 50 at the first 40 and second 42 lateral sides. The fastening portions 50 are here embodied as a plurality of plates extending from the ram 6. The ram 6 is attached to the base 2 at the plurality of fastening portions via a first plurality of hydraulic cylinders, which comprises a first 20, a second 22 and a third 24 hydraulic cylinder, visible in FIG. 1. The first plurality of hydraulic cylinders further comprises fourth to sixth hydraulic cylinders on the opposite side of the bale press 1, not visible in FIG. 1.

The ram 6 is attached to the top 4 at the plurality of fastening portions via a second plurality of hydraulic cylinders, which comprises a seventh 30, an eighth 32 and a ninth 34 hydraulic cylinder, visible in FIG. 1. The second plurality of hydraulic cylinders further comprises tenth to twelfth hydraulic cylinders on the opposite side of the bale press 1, not visible in FIG. 1.

Each of the hydraulic cylinders of the first and second pluralities of hydraulic cylinders comprise a barrel and a piston rod. The ram 6 is attached via the piston rods to the hydraulic cylinders. The barrels of the first to sixth hydraulic cylinders are attached to the base 2. The barrels of the seventh to twelfth hydraulic cylinders are attached to the top 4. The hydraulic cylinders work together to move the ram 6 up and down, the ram 6 being guided along the pillars 16.

The first to twelfth hydraulic cylinders are configured and/or sized such that a force to the first bale 12 and the second bale 14 can be applied in the range of 2,000 to 40,000 kN, preferably 500 to 25,000 kN. For instance, a force of 15,000 kN (about 1500 metric tons) may be applied in total by the first to twelfth hydraulic cylinders.

A force of 15,000 kN is suitable for bales of about 250 kg, when having a footprint of about 0.5 or 0.6 m² (for instance 80 cm long and 70 cm wide bales). In this example, the height of the bale will compress by about a factor of two thirds (about 0.66), from 60 cm to 40 cm. Due to the compressing, air is pressed out of the pulp bales.

The base 2 comprises a first pressing surface 7. The ram 6 comprises a second pressing surface 8 facing the first pressing surface 7. In addition, the ram 6 comprises a third pressing surface 9 facing the top 4. The top 4 comprises a fourth pressing surface 10 facing the third pressing surface 9.

The ram 6, top 4 and base 2 are made from materials and are configured such that they are suitable for applying the pressures mentioned above and below to the pulp bales. Suitable materials may comprise steel. A suitable configuration for the base 2 may be that it comprises a solid base part underneath at least the first pressing surface 7. A suitable configuration for the ram 6 may be that it comprises a solid ram part underneath the second pressing surface 8 and underneath the third pressing surface 9. A suitable configuration for the top 2 may be that it comprises a solid top part underneath the fourth pressing surface 10.

The pulp bale press 1 is configured to receive the first bale 12 to be compressed between the first pressing surface 7 and the second pressing surface 8. Here, the first chain conveyor 52 moves the first bale 12 towards the first pressing surface 7. The base 2 comprises a first positioner, such as a conveyor belt, for positioning the pulp bales on the first pressing surface 7. The first bale 12, when positioned onto the first pressing surface 7 underneath the ram 6, is compressed by movement of ram 6 towards the base 2.

The pulp bale press 1 is further configured to receive the second bale 14 to be compressed between the third pressing surface 9 and the fourth pressing surface 10. The ram 6 comprises a second positioner, such as a conveyor belt, for positioning the pulp bales on the third pressing surface 9. The second bale 14, when positioned onto the third pressing surface 9 underneath the top 4, is compressed by movement of the movable pressing element 6 towards the top 4.

The above configuration, in other words, provides for two bale pressing levels in the pulp bale press 1. A first pressing level is between the base 2 and the ram 6. A second pressing level is between the ram 6 and the top 4. The functioning of this two-level pulp bale press is further described below. Although the described functioning of the pulp bale press is not limited to starting up the press, it is noted that starting up of the pulp bale press 1 may be performed by feeding a pulp bale to the first pressing level first or to the second pressing level first.

The first 7 and second 8 pressing surfaces are substantially parallel and the third 9 and fourth 10 pressing surfaces are substantially parallel. The second 8 and fourth 10 pressing surfaces may comprise various protrusions, grooves, and/or notches or the like, depending on the needs of the pulp bale producer.

The pulp bale press 1 comprises a first chain conveyor 52 and a second chain conveyor 54. These first 52 and second 54 chain conveyors are an implementation of respective input transporters. The input transporters are for inputting the first 12 and second 14 pulp bales to be compressed into the pulp press 1. The pulp bale press 1 further comprises a third chain conveyor 56 and a fourth chain conveyor 58. These third 56 and fourth 58 chain conveyors are an implementation of respective output transporters for outputting compressed bales. These third 56 and fourth 58 chain conveyors are an implementation of respective output transporters.

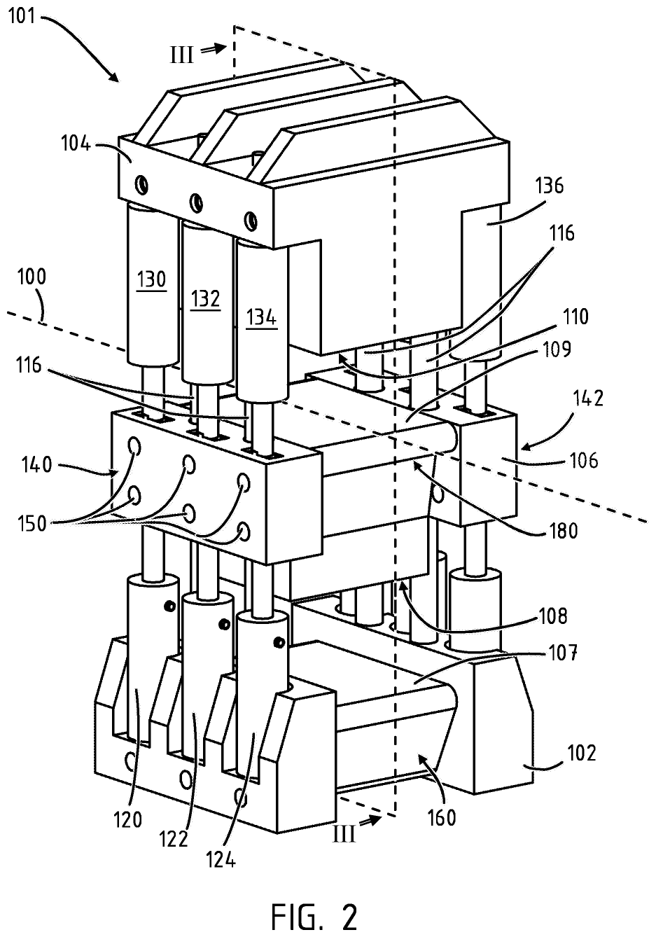

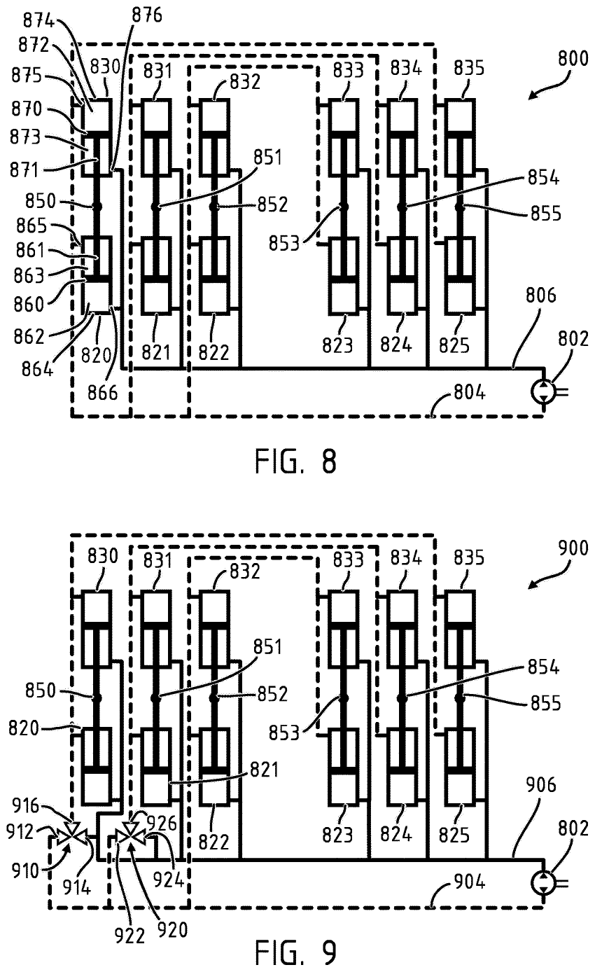

A pulp bale press 101 according to another embodiment is shown in FIG. 2. The features/components of the pulp bale press 101 corresponding to the features of the pulp bale press 1 have the same function as in the pulp bale press 1 as described above. The corresponding features have reference numerals with 100 added to the reference numerals in FIG. 1. Features not explicitly indicated with reference numerals may still be present in the press 101 like in the press 1. If not mentioned otherwise, the features and functioning of the pulp bale press 101 are the same as of the pulp bale press 1. The pulp bale press 101 shows particular implementations of the first and second positioners described above. A cross section showing the implementations of the positioners is indicated in FIG. 2 and can be seen in FIG. 3.

The pulp bale press 101 comprises a base 102 which is connected to the top 104 via pillars or columns 116, which extend from the base to the top. The pillars or columns 116 are an embodiment of the one or more connecting elements. Between the pillars 116 are openings for in- and outputting the first pulp bale 112 and the second pulp bale 114. The bale press 101 comprises a movable pressing element 106, herein further referred to as ram 106. The ram 106 is movable arranged and is guided along the pillars 116, for instance using bearings. The ram 106 comprises a first lateral side 140 and a second lateral side 142 opposite the first lateral side, both lateral sides extending parallel to first axis 100. The ram 106 comprises a plurality of fastening portions at the first 40 and second 42 lateral sides. The fastening portions are here embodied on an inner side of the ram 106 and are therefore not visible. The ram 106 is attached to the base 102 at the plurality of fastening portions via a first plurality of hydraulic cylinders, which comprises a first 120, a second 122 and a third 124 hydraulic cylinder, visible in FIG. 2. The first plurality of hydraulic cylinders further comprises fourth to sixth hydraulic cylinders on the opposite side of the bale press 101, not indicated with reference numerals in FIG. 2.

The ram 106 is attached to the top 104 at the plurality of fastening portions via a second plurality of hydraulic cylinders, which comprises a seventh 130, an eighth 132 and a ninth 134 hydraulic cylinder, visible in FIG. 2. The second plurality of hydraulic cylinders further comprises tenth to twelfth hydraulic cylinders on the opposite side of the bale press 101, of which the tenth hydraulic cylinder 136 is visible in FIG. 2. The press 101 comprises entry openings 150, which provide access to fasteners used to fasten the first to third and seventh to ninth hydraulic cylinders to the ram 106 at its fastening portions. Further openings are present at the lateral side 142 for providing access to fasteners used to fasten the fourth to sixth and tenth to twelfth hydraulic cylinders.

The base 102 comprises a first pressing surface 107. The ram 106 comprises a second pressing surface 108 facing the first pressing surface 107. In addition, the ram 106 comprises a third pressing surface 109 facing the top 104. The top 104 comprises a fourth pressing surface 110 facing the third pressing surface 109.

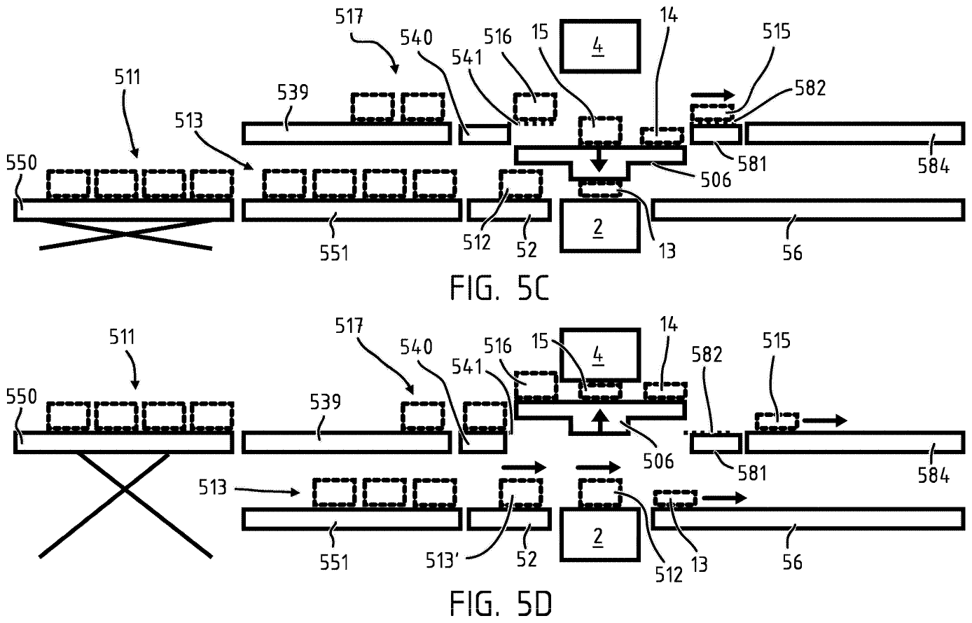

Referring now to FIG. 8, there is shown a schematic flow chart of a hydraulic system 800 used in any one of the pulp bale presses described above and below. The hydraulic system 800 is configured for supplying hydraulic fluid to the first and second pluralities of hydraulic cylinders. Here, the first plurality of hydraulic cylinders comprises the hydraulic cylinders 820, 821, 822, 823, 824 and 825. The second plurality of hydraulic cylinders in this embodiment comprises hydraulic cylinders 830, 831, 832, 833, 834, and 835. The hydraulic cylinders 820-825 and 830-835 may be respectively hydraulic cylinders 20-25 and 30-35, or respectively hydraulic cylinders 120-125 and 130-135.

The hydraulic system 800 may comprise a pump 802 hydraulically connected to the first 820-825 and second 830-835 hydraulic cylinders. As shown in FIG. 8, hydraulic cylinder 820 comprises a piston 860 arranged in a barrel 864. The piston 860 is attached to piston rod 861, which extends out from the barrel 864 and is connected to the ram 6 or 106, schematically shown at attachment point 850. Hydraulic cylinder 820 comprises a first hydraulic fluid chamber 862 and a second hydraulic fluid chamber 863. The hydraulic cylinder 820 comprises a first hydraulic fluid port 865 for allow hydraulic fluid to flow into and out of the first hydraulic fluid chamber 862. The hydraulic cylinder 820 further comprises a second hydraulic fluid port 866 for allowing hydraulic fluid to flow into and out of the second hydraulic fluid chamber 863. Hydraulic cylinder 830 comprises a piston 870 arranged in a barrel 874. The piston 870 is attached to piston rod 871, which extends out from the barrel 874 and is connected to the ram 6 or 106, schematically shown at attachment point 850. Hydraulic cylinder 830 comprises a first hydraulic fluid chamber 872 and a second hydraulic fluid chamber 873. The hydraulic cylinder 830 comprises a first hydraulic fluid port 875 for allow hydraulic fluid to flow into and out of the first hydraulic fluid chamber 872. The hydraulic cylinder 830 further comprises a second hydraulic fluid port 876 for allowing hydraulic fluid to flow into and out of the second hydraulic fluid chamber 873.

In order to push the piston rod 861 in an outward direction relative to the barrel 864, the (pressurized) hydraulic fluid is input into the first hydraulic fluid chamber 862. It will be apparent that the first hydraulic fluid chamber 862 then increases in size, and that the second hydraulic fluid chamber 863 reduces in size. In order move the piston rod 861 into the barrel 864, the (pressurized) hydraulic fluid is input into the second hydraulic fluid chamber 863. Now, the first hydraulic fluid chamber 862 reduces in size, and the second hydraulic fluid chamber 863 increases in size. This way of operating an individual hydraulic cylinder is the same as for the other hydraulic cylinders 821-825 and 830-835.

The hydraulic cylinders 821-825 and 831-835 are similarly configured as hydraulic cylinders 820 and 830. Their respective pistons, barrels, and piston rods, hydraulic fluid chambers and first and second hydraulic fluid ports are not labelled with a reference numeral for sake of clarity. The piston rods of hydraulic cylinders 821 and 831 are in mechanical connection with ram 6 or 106, as schematically shown by attachment point 851. The piston rods of hydraulic cylinders 822 and 832 are in mechanical connection with ram 6 or 106, as schematically shown by attachment point 852. The piston rods of hydraulic cylinders 823 and 833 are in mechanical connection with ram 6 or 106, as schematically shown by attachment point 853. The piston rods of hydraulic cylinders 824 and 834 are in mechanical connection with ram 6 or 106, as schematically shown by attachment point 854. The piston rods of hydraulic cylinders 825 and 835 are in mechanical connection with ram 6 or 106, as schematically shown by attachment point 855.

The hydraulic pump 802 is configured to supply pressurized hydraulic fluid to a first hydraulic fluid branch 804 causing one or more hydraulic cylinders of the first plurality of hydraulic cylinders 820-825 and second plurality of hydraulic cylinders 830-835 to move the ram 6 or 106 towards the base 2 or resp. 102. This movement may be schematically shown as a downward movement of attachment point 850. The hydraulic pump 802 is further configured to supply pressurized hydraulic fluid to a second hydraulic fluid branch 806 causing one or more of the first 820-825 and second 830-835 hydraulic cylinders to move the ram 6 or 106 towards the top 4 or resp. 104. This movement may be seen schematically as an upward movement of attachment point 850. Hydraulic pump 802 may be a bidirectional pump. Bidirectional pump here indicates that the pump is configured to switch the flow direction. One example of a bidirectional pump is a pump that can reverse its rotation direction. Another example is a variable displacement piston pump, that can reverse its flow direction while keeping the same rotation direction. Yet another example is to use a unidirectional pump together with one or more valves to reverse the flow direction. Alternatively, hydraulic pump 802 may be implemented as two pumps, e.g. unidirectional pumps, each pump supplying pressurized hydraulic fluid to a respective one of hydraulic branches 804 and 806.

The first hydraulic fluid branch 804 may comprise the respective first hydraulic fluid chambers (including first hydraulic fluid chamber 872) of the second plurality of hydraulic cylinders 830-835 and the respective second hydraulic fluid chambers (including second hydraulic fluid chamber 863) of the first hydraulic fluid cylinders 820-825. The second hydraulic fluid branch 806 may comprise the respective first hydraulic fluid chambers (including first hydraulic fluid chamber 862) of the first plurality of hydraulic cylinders 820-825 and the respective second hydraulic fluid chambers (including second hydraulic fluid chamber 873) of the second plurality of hydraulic fluid cylinders 830-835.

The first hydraulic fluid branch 804 is hydraulically connected to the respective second hydraulic fluid chambers of the first plurality of hydraulic cylinders 820-825 and to the respective first hydraulic fluid chambers of the second plurality of hydraulic cylinders 830-835. The second hydraulic fluid branch 806 is hydraulically connected to the respective first hydraulic fluid chambers of the first plurality of hydraulic cylinders 820-825 and to the respective second hydraulic fluid chambers of the second plurality of hydraulic cylinders 830-835. In order to press a pulp bale between the base and the ram, the first hydraulic fluid branch 804 is pressurized. Hydraulic fluid from the second hydraulic fluid branch flows towards the pump and is pressurized. More fluid may be supplied by the hydraulic fluid reservoir (not shown) if needed. In order to press a pulp bale between the ram and the top, the second hydraulic fluid branch 806 is pressurized. Hydraulic fluid from the first hydraulic fluid branch flows towards the pump and is pressurized. More fluid may be supplied by the hydraulic fluid reservoir (not shown) if needed. When the hydraulic fluid branches 804 and 806 are substantially the same size, a smaller hydraulic fluid reservoir, if any, is needed.

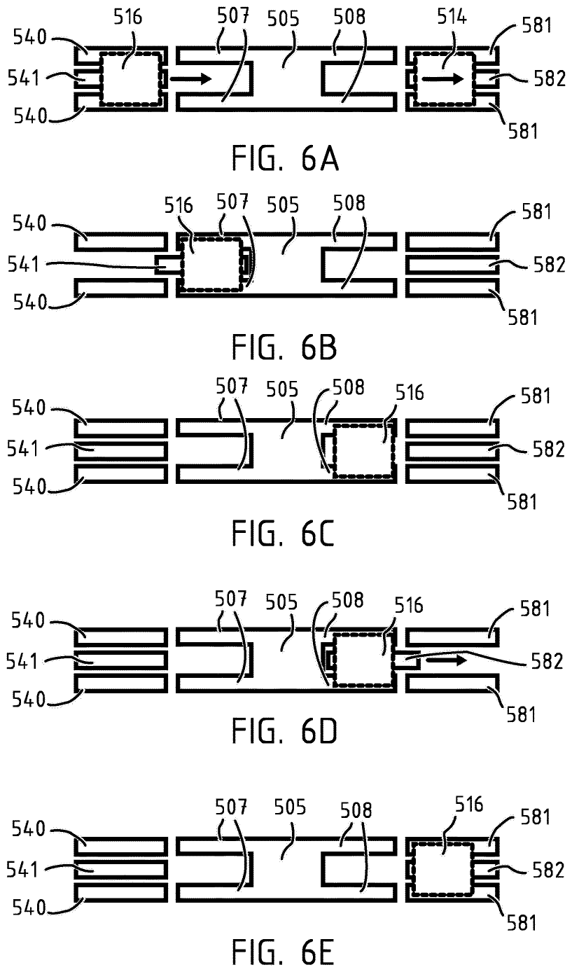

Hydraulic system 900 (FIG. 9) is the same as hydraulic system 800 except for the following. The hydraulic system 900 comprises a first valve 910 and a second valve 920. The first valve 910 comprises a first valve port 912 hydraulically connected to the pump 802 via the first hydraulic fluid branch 904, a second valve port 914 connected to the pump 802 via the second hydraulic fluid branch 906 and a third valve port 916 connected to the respective first hydraulic fluid chambers of the hydraulic cylinders 830 and 835 and the respective second hydraulic fluid chambers of the hydraulic cylinders 820 and 825.

The first valve 910 comprises two valve positions. In the first valve position, the first valve port 912 and the third valve port 916 are in hydraulic fluid connection, such that hydraulic fluid can flow via the first hydraulic fluid branch 904 to/from the respective first hydraulic fluid chambers of the hydraulic cylinders 830 and 835 and to/from the respective second hydraulic fluid chambers of the hydraulic cylinders 820 and 825. In the first valve position, no hydraulic fluid can pass the second valve port 914. In this first valve position, the hydraulic cylinders 820 and 825 and hydraulic cylinders 830 and 835 work as in the hydraulic system 800.

In the second valve position, the second valve port 914 and the third valve port 916 are in hydraulic fluid connection, such that hydraulic fluid can flow to/from the respective first hydraulic fluid chambers of the hydraulic cylinders 830 and 835 and to/from the respective second hydraulic fluid chambers of the hydraulic cylinders 820 and 825. In this position, no hydraulic fluid can pass the first valve port 912. In this second valve position, the pressure difference between the respective fluid chambers of the hydraulic cylinders 820 and 825 and hydraulic cylinders 830 and 835 becomes zero or negligible, and these hydraulic cylinders are then in the above mentioned free moving state or mode, or hydraulic “short circuiting” mode. Since the same liquid volume from the pump is to be applied to the remaining, non-short circuiting, hydraulic cylinders 821-824 and 831-834, they will move faster.

The first hydraulic fluid chamber 872 of the seventh hydraulic cylinder 830, the second hydraulic fluid chamber 863 of the first hydraulic cylinder 820, the first hydraulic fluid chamber of the twelfth hydraulic cylinder 835, the second hydraulic fluid chamber of the sixth hydraulic cylinder 825, and the hydraulic connections between these chambers and the valve 910 are thus an embodiment of a first subbranch of the first hydraulic fluid branch 904. The hydraulic connection between the pump 802 and the valve 910 is an embodiment of a second subbranch of the second hydraulic fluid branch 906.

Similarly, the first hydraulic fluid chamber of the eighth hydraulic cylinder 831, the second hydraulic fluid chamber of the second hydraulic cylinder 821, the first hydraulic fluid chamber of the eleventh hydraulic cylinder 834, the second hydraulic fluid chamber of the fifth hydraulic cylinder 824, and the hydraulic connections between these chambers and the valve 920 are an embodiment of another first subbranch of the first hydraulic fluid branch 904. The another first subbranch is connectable to the second subbranch via the valve 920.

The second valve 920 comprises a fourth valve port 922 hydraulically connected to the pump 802 via the first hydraulic fluid branch 904, a fifth valve port 924 connected to the pump 802 via the second hydraulic fluid branch 906 and a sixth valve port 926 connected to the respective first hydraulic fluid chambers of the hydraulic cylinders 831 and 834 and the respective second hydraulic fluid chambers of the hydraulic cylinders 821 and 824. The functioning of the second valve 920 is the same as for valve 910, now in relation to the hydraulic cylinders 821, 824, 831 and 834. In the respective second valve position of the second valve 920, the pressure difference between the respective fluid chambers of the hydraulic cylinders 821 and 824 and hydraulic cylinders 831 and 834 becomes zero or negligible, and these hydraulic cylinders are then in the above mentioned free moving state or mode, or hydraulic “short-circuiting” mode. When the first valve 820 and second valve 920 are both in their respective second valve positions, only hydraulic cylinders 822, 823 and 832 and 833 can be used to move the ram 6 or 106. The ram 6 or 106 can then be moved even faster.

The hydraulic system 1000 is the same as hydraulic system 900 except for the following. The hydraulic system 1000 comprises third valve 1020. The third valve 1020 comprises a seventh valve port 1022 hydraulically connected to the pump 802 via the first hydraulic fluid branch 904, a eighth valve port 1024 connected to the pump 802 via the second hydraulic fluid branch 906 and a ninth valve port 1026 connected to the respective first hydraulic fluid chambers of the hydraulic cylinders 832 and 833. The functioning of the second valve 920 is the same as for valve 910, now in relation to the hydraulic cylinders 832 and 833. In the respective second valve position of the second valve 1020, the pressure difference between the respective first fluid chambers of the hydraulic cylinders 832 and 833 becomes zero or negligible, and these hydraulic cylinders are then in the above mentioned free moving state or mode, or hydraulic “short-circuiting” mode. When the first valve 820, the second valve 920 and the third valve 1020 are in their respective second valve positions, only hydraulic cylinders 822 and 823 can be used to move the ram 6 or 106. The ram 6 or 106 can then be moved even faster than when both valves of FIG. 9 are in their second valve positions.

The respective valve positions of valves 910, 920 and 1020 are controllable by the one or more controllers. One or more of the valves 910, 920 and 1020 can be put into the second valve position. The valves 910, 920, and 1020 may be controlled such that they are in their respective first valve positions when compressing, or just about to compress and thereafter compressing, a pulp bale. In this mode, full pressure can be applied to the pulp bale by the ram 6 or 106.

After compressing this pulp bale, the ram is to be moved to the opposite direction. The hydraulic fluid flow is shifted towards the other hydraulic fluid branch, e.g. to branch 904 when a bale has just been compressed between the ram and the top. One or more of the valves 910, 920 and 1020 are then controlled to be shifted from their respective first valve position to their respective second valve position. The remaining cylinders that can still be pressurized now work to move the ram in the other direction, e.g. towards the base when fluid branch 904 is pressurized.

When the ram reaches a position wherein a bale is to be compressed, the valves that are in their respective second valve positions shift back to their respective first positions so that full pressure can be applied to the bale to be compressed.

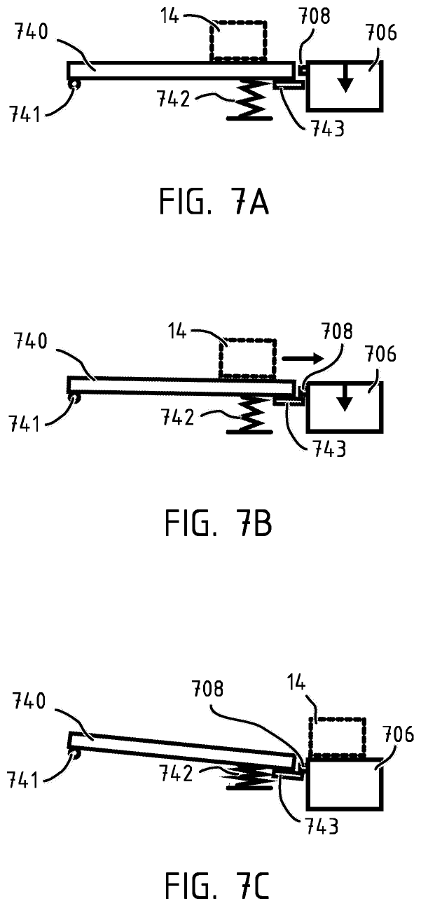

Hydraulic systems 800, 900 and 1000 may each comprise further components not shown in FIGS. 8-10, such as one or more hydraulic fluid reservoirs hydraulically connected to the pump, one or more additional valves configured so as to selectably supply hydraulic fluid to the one or more of the first and second pluralities of hydraulic cylinders, control systems, hydraulic fluid cooling devices, etc. The one or more controllers may be configured to control the hydraulic system. The hydraulic system may alternatively comprise one or more hydraulics controllers comprised in the one or more controllers.

The cross section of FIG. 3 shows the first pulp bale 12 in a position on the base 102 such that it can be compressed by the ram 106. The second pulp bale 14 has in this figure been compressed. The base 102 comprises the belt conveyor 160, which is an implementation of a conveyor. The belt conveyor 160 comprises a belt 162, upper rollers 164 and 166 and lower rollers 168 and 170. The belt 162 in this embodiment goes around a solid base part 103 of the base 102. The solid base part is arranged such that the pulp bale 12 is compressed. The belt 162 moves along an upper surface of the solid base part 103. The belt 162 thus remains between the pulp bale 12 and the solid base part 103. In other words, an upper or outer surface of the belt 162 represents the first pressing surface 107. The belt conveyor 160 can be drive by one or more electrical motors which are controlled by one or more controllers (not shown). An advantage of using a belt is that it complements the upper surface of the solid base part 103 and thus allows the bale to be pressed with the belt between the solid base part 103 and the bale 12. The ram 106 comprises the belt conveyor 180, which is an implementation of a conveyor. The belt conveyor 180 comprises a belt 182, and rollers 188 and 190. The belt 182 comprises outer belt section 184 and inner belt section 186, which thus means that the belt 182 in this case runs along itself along the upper surface of the solid ram part 105. The third pressing surface 109 is here represented by the outer belt section 184. The advantage of this belt configuration is that the second bale 14 can be moved along the ram 106 even when the ram 106 is pressing the first bale 12. Use of a conveyor belt further results in a compress conveyor. FIG. 3 is merely schematically indicating the functioning of the conveyors. For instance, sharp edges may be visible, and spacing between the belt(s) and other parts of the press 101, that in practice would not be present. These sharp edges may be rounded and/or may include further rollers of so needed for instance to reduce wear of the belt.

The belts conveyors 162 and 180 may be split into two separate belt conveyors each (not shown), for instance parallel to the axis 100, so that these separate belts may be controlled separately so that the respective bales can also be rotated on the first 107 and third 109 pressing surfaces.

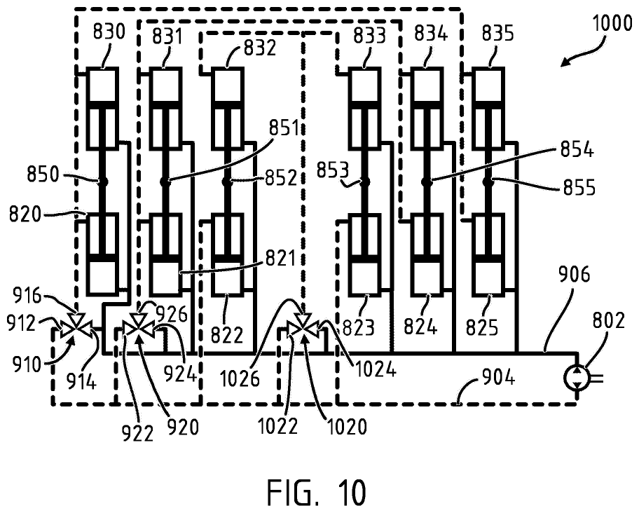

The pulp bale press 1 comprises one or more controllers configured to control the movement of the ram 6. The one or more controllers may be configured to allow input of the second bale 14 onto the ram 6 when the ram 6 is in a first position in which the top 2 and the ram 6 are sufficiently distanced to receive the second pulp bale 14 to be compressed. This is further explained with reference to FIGS. 4, 5 and 6.

Referring to FIGS. 4A-4H, a method of compressing pulp bales in the pulp bale press 1 or 101 comprises inputting S200 the first bale 12 to be compressed between the base 2 and the ram 6. FIG. 4B shows the first bale 12 in a position wherein it is between the base 2 and the ram 6. After the step S200 of inputting the first bale, the method comprises the step S202 of compressing the first bale 12 by moving the ram 6 towards the base 2 (FIG. 4C). When the ram 6 has moved to a first position in which the top 2 and the ram 6 are sufficiently distanced to receive the second pulp bale 14, the method includes the step S204 of inputting the second bale 14 to be compressed between the ram 6 and the top 4. Thereafter, the step S206 of compressing the second bale 14 by moving the ram 6 towards the top 4 is performed.

The method includes, when the ram 6 has moved to a second position in which the second pressing surface 8 is not in contact with the compressed first pulp bale 12, the step S208 of outputting the compressed first bale 12 from the first pressing surface 7. When during or after outputting S208 the compressed first bale 12 from the first pressing surface 7 the ram 6 has moved to a third position in which the first pressing surface 7 and the second pressing surface 8 are sufficiently distanced to receive a third pulp bale 13 to be compressed, a step of inputting the third pulp bale 13 to be compressed between the first pressing surface 7 and the second pressing surface 8.

The method further comprises, when the ram 6 has moved to a fourth position in which the fourth pressing surface 10 is not in contact with the compressed second pulp bale 14, outputting S212 the compressed second bale 14 from the third pressing surface 9 of the ram 6.

When during or after outputting S212 the compressed second pulp bale 14 from the fourth pressing surface 10 the ram 6 has moved to a fourth position in which the third pressing surface 9 and the fourth pressing surface 10 are sufficiently distanced to receive a fourth pulp bale 15 to be compressed, the step of inputting the fourth pulp bale 15 to be compressed between the third pressing surface 9 and the fourth pressing surface 10.

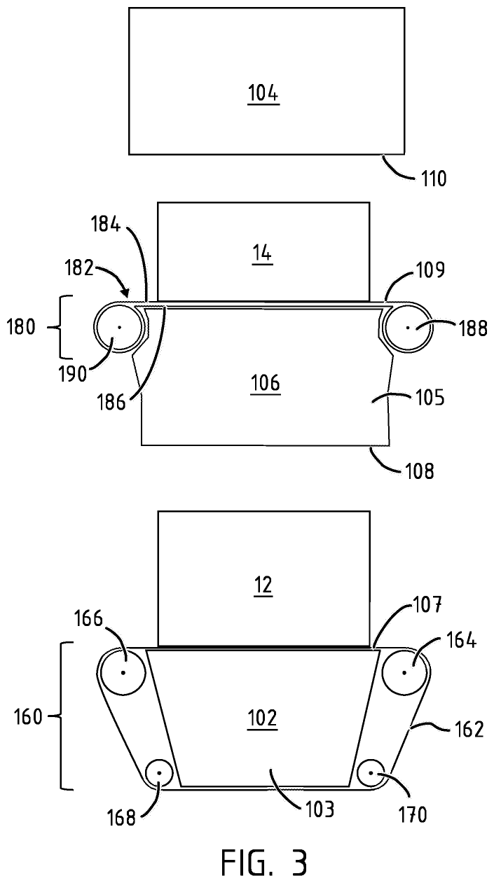

In order to allow the pulp bale press 1 or 101 to press more bales per unit of time, it is beneficial to feed the pulp bales onto the ram 6 while it is moving. FIGS. 5, 6 and 7 show configurations of the pulp bale press that allow for this feeding while ram 6 is moving.

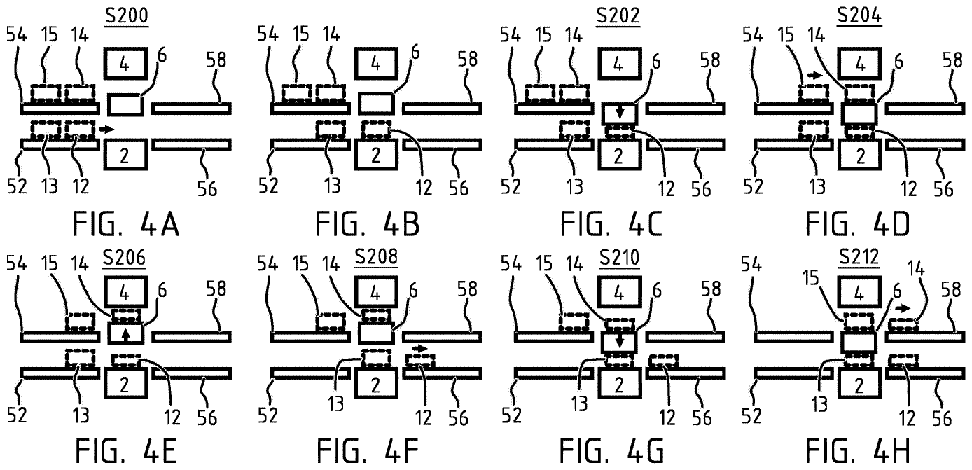

In FIGS. 5 and 6, the ram 506 comprises a ram base part 505, a first ram extension 507 extending towards input conveyor 540 and a second ram extension 508 extending towards output conveyor 581. In other words, the first 507 and second 508 ram extension extend parallel to the axis 100. The input conveyor 540 is fed by the chain conveyor 539. The input 540 and output 581 conveyor are here implemented as chain conveyors. The first and second ram extensions comprise conveyors, which are here implemented as chain conveyors. The ram base part 505 comprises a belt conveyor along its upper surface as shown in FIG. 2.

The output conveyor 581 comprises a second extendable arm 582. In the position of FIG. 5A, the second extendable arm 582, which is indicated with a dashed line, is in its extended position, similar to the position shown in the top view of FIG. 6D. The second extendable arm 582 is configured to extend such that its extended position overlaps with the second ram extension 508 of the ram 506 when viewed along the axis 100, which is in a horizontal direction in the FIGS. 5A-5D. The second extendable arm 582 and the second ram extension 508 are complementarily shaped such that when the ram 506 moves up towards the top 4 or down towards the base 2, the first extendable arm 541 and the first ram extension 507 can pass each other without blocking each other. In this embodiment, the second ram extension 508 is fork shaped, and the second extendable arm 582 extends between the space between the fork shape of the second ram extension 508 (FIG. 6D).

In FIG. 5A, the compressed pulp bale 515 is positioned on the second ram extension 508 when the ram 506 is in an upward position in which it is pressing the pulp bale 14. The second extendable arm 582 is in its extended position underneath the second ram extension 508 and the pulp bale 515. After the pressing of the pulp bale 14 is finished, the ram 506 moves down (FIG. 5B) and the pulp bale 515 is held up by the second extendable arm 582. Thereafter, the second extendable arm 582 retracts (FIG. 5C) such that the compressed pulp bale 515 can be transported along the conveyor 584. The conveyor 584 is separate from the output conveyor 581, so that their respective conveying means, such as chains, can be individually operated.

The input conveyor 540 comprises a first extendable arm 541. The first extendable arm 541 is configured to extend such that its extended position overlaps with the first extension 507 of the ram 506 when viewed along the axis 100, which is in a horizontal direction in the FIGS. 5A-5D. The first extendable arm 541 and the first ram extension 507 are complementarily shaped such that when the ram 506 moves up towards the top 4 or down towards the base 2, the first extendable arm 541 and the first ram extension 507 can pass each other without blocking each other. In this embodiment, the first ram extension 507 is fork shaped, and the first extendable arm 541 extends between the space between the fork shape of the second ram extension (FIG. 6B).

In FIG. 5A, pulp bale to be compressed 516 is positioned onto the first conveyor 540. A similar position is shown in FIG. 6A. Once the pulp bale 15 has moved away from the first ram extension 507 such that it is in a position on the ram 506 to be compressed, and the ram 506 is in a downward or lower position (FIG. 5C) the first extendable arm 541 extends towards the ram 506, taking pulp bale 516 with it (FIG. 6B). Then, once the ram 506 moves upwards again to press the pulp bale 15, the first ram extension 507 takes the pulp bale 516 with in an upward direction towards the top 4. Thereafter the first extendable arm 541 retracts again (FIG. 6C). The pulp bale to be compressed 517′ then takes position onto the input conveyor 540.

Once the pulp bale 516 is compressed, it is moved onto the second ram extension 508 (FIG. 6C). The second extendable arm 582 extends underneath the ram 506 and the pulp bale 516 (FIG. 6D), and once the ram 506 moves down again towards the base, the pulp bale 516 is held upward by the second extendable arm 582. Thereafter, the second extendable arm 582 retracts so that the pulp bale 516 can be transported away by the output conveyor 581 towards the conveyor 584.

The first additional chain conveyor 551 holds several pulp bales waiting to be compressed 513. The first chain conveyor 52 is then fed by the first additional conveyor 551. The first chain conveyor 52 and the first additional chain conveyor 551 are separated in order to show that these conveyors have individual sets of chains, so that the first chain conveyor 52 can feed the base 2 with a pulp bale independently of the first additional chain conveyor 551. The same holds for the input conveyor 540 and the additional input conveyor 539.

The first additional chain conveyor 551 and the additional input conveyor 539 are both fed with additional pulp bales 511 by the lift conveyor 550, which is configured to move between a first position in which it can feed the first additional chain conveyor 551 with pulp bales to be compressed and a second position in which it can feed the additional input conveyor 539 with pulp bales to be compressed. Alternatively, there may be first and second fixed chain conveyors, of which the first moves half of the pulp bales to be compressed towards the first additional chain conveyor 551 and the second moves the other half of pulp bales to be compressed towards the additional input conveyor 539.

It will be understood that alternatively the extendable arms could be implemented on the ram, and the fork shaped part on the in-and output conveyors. For sake of stability of the pulp bales, however, it is preferred that the ram comprises the fork shaped extensions. Moreover, the extendable arms can be implemented as forks as well, such that the two fork shapes fit into each other. Any fork shape mentioned here may have two or more arms.

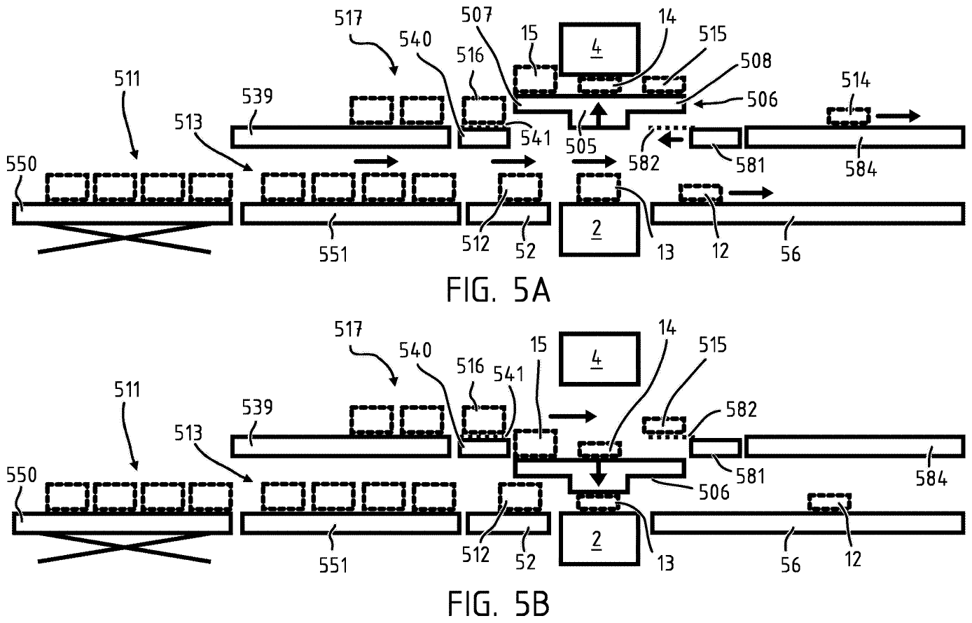

An alternative configuration to allow in-and outputting of the ram with pulp bales to be compressed while moving is shown in FIGS. 7A-7C. A rotatable input conveyor 740 is rotatably fixed by hinge 741. The rotatable input conveyor 740 is further fixed at a ram 706 facing end thereof by an elastic body, here embodied as a spring 742. The spring 742 is fixed to the rotatable input conveyor 740 at one end thereof and fixed to a stationary fixation point at the other end thereof. The rotatable input conveyor 740 comprises a first extension 743 at the ram 706 facing part thereof. The ram 706 in turn comprises a second extension 708 extending towards the rotatable input conveyor 740. In a resting position, the rotatable input conveyor 740 is positioned similar to the second chain conveyor 54. The ram 706 is an embodiment of the ram of the pulp bale presses according to the invention and is thus positioned between the top 4 and the base 2. The other features and functioning not mentioned in relation to FIGS. 7A-7C are the same as for the other embodiments described above.

The first 743 and second 708 extensions are positioned complementarily such that the second extension 708 pushes down on the first extension 743 when the ram 706 moves in a downward direction towards the base 2 (not shown in FIGS. 7A-7C) in order to compress a pulp bale positioned on the base 2. Then, the rotatable input conveyor 740 is pulled along with the ram 6 and remains aligned with an outer edge of the ram 706. The bale 14 can be feed onto the ram 708 independent of the vertical position of the ram 706, as long as there is sufficient space between the ram 706 and the top 4 to receive a pulp bale to be compressed, here pulp bale 14. A partially rotated or downward position is shown in FIG. 7B. A fully rotated or downward position is shown in FIG. 7C. When the ram 706 moves back up towards the top 4, the rotatable input conveyor 740 rotates back due to the upwards urge provided by the spring 742.

Alternative to the use of the first 743 and second 708 extensions, the rotation may be controlled by suitable hydraulic equipment or an electric motor. In general, the position of the ram facing bale input edge of the rotatable input conveyor is aligned with the rotatable input conveyor facing upper outer edge of the ram 706.

Similar configurations are provided for a rotatable pulp bale output conveyor, of which a position of the ram facing bale output edge of the rotatable output conveyor is aligned with the rotatable output conveyor facing upper outer edge of the ram 706.

Mixtures of the embodiments of FIGS. 5-6 and FIG. 7 are foreseen as well, for instance the in-or output side having the fork configuration of FIGS. 5-6 and the other side having the configuration of FIG. 7.

Although the present invention has been described with reference to specific embodiments, also shown in the appended drawings, it will be apparent to those skilled in the art that many variations and modifications can be done within the scope of the invention as described in the specification and defined with reference to the claims below.

1-19. (canceled)

20. A pulp bale press for compressing pulp bales and configured for use in a pulp bale production line, comprising:
a base;
a top positioned opposite the base and connected to the base; and
a movable pressing element configured to move between the base and the top, wherein:
the pulp bale press is configured to compress a first pulp bale to be compressed between the base and the movable pressing element and to compress a second pulp bale to be compressed between the top and the movable pressing element,
the movable pressing element is movably attached to the base via a first plurality of hydraulic cylinders comprising at least two hydraulic cylinders, and
the movable pressing element is movably attached to the top via a second plurality of hydraulic cylinders comprising an equal number of hydraulic cylinders as the first plurality of hydraulic cylinders.

21. The pulp bale press according to claim 20, wherein:
the base comprises a first pressing surface,
the movable pressing element comprises a second pressing surface facing the first pressing surface and a third pressing surface facing the top,
the top comprises a fourth pressing surface facing the third pressing surface, and
the pulp bale press is configured to receive the first bale to be compressed between the first pressing surface and the second pressing surface, compress the first bale by movement of the movable pressing element towards the base, receive the second bale to be compressed between the third pressing surface and the fourth pressing surface, and compress the second bale by movement of the movable pressing element towards the top.

22. The pulp bale press according to claim 20, wherein the first plurality of hydraulic cylinders comprises at least four hydraulic cylinders.

23. The pulp bale press according to claim 20, wherein:
the movable pressing element is configured to receive the second bale along a first axis thereof;
the movable pressing element comprises first and second lateral sides extending parallel to the first axis;
an equal number of the first plurality of hydraulic cylinders is attached the movable pressing element to each of the first and second lateral sides; and
an equal number of the second plurality of hydraulic cylinders is attached the movable pressing element to each of the first and the second lateral sides.

24. The pulp bale press according to claim 20, wherein the first plurality of hydraulic cylinders has a total first volume and the second plurality of hydraulic cylinders has a total second volume, wherein the total first volume is substantially equal to the total second volume.

25. Pulp bale press according to claim 20, comprising one or more controllers configured to control the movement of the movable pressing element.

26. The pulp bale press according to claim 25, wherein the one or more controllers are configured to control hydraulic fluid flow towards and from the first plurality of hydraulic cylinders and the second plurality of hydraulic cylinders to control the movement of the movable pressing element.

27. The pulp bale press according to claim 26, further comprising a hydraulic pump hydraulically connected to the first plurality of hydraulic cylinders and the second plurality of hydraulic cylinders, wherein the one or more controllers are configured to control the hydraulic pump such that the movement of the movable pressing element is controlled.

28. The pulp bale press according to claim 27, wherein the hydraulic pump is configured to supply pressurized hydraulic fluid to a first hydraulic fluid branch causing one or more hydraulic cylinders of the first and second pluralities of hydraulic cylinders to move the movable pressing element towards the base and to a second hydraulic fluid branch causing one or more hydraulic cylinders of the first and second pluralities of hydraulic cylinders to move the movable pressing element towards the top.

29. The pulp bale press according to claim 28, wherein one or more first subbranches of the first hydraulic fluid branch are hydraulically connectable to respective one or more second subbranches of the second hydraulic fluid branch via one or more hydraulic valves such that one or more hydraulic cylinders of the first and second pluralities hydraulic cylinders are in a free moving state while the first or the second hydraulic fluid branch is pressurized.

30. The pulp bale press according to claim 20, wherein the top is connected to the base by one or more connecting elements, wherein the pulp bale press is configured such that the movable pressing element is guided along the one or more connecting elements.

31. The pulp bale press according to claim 20, configured to apply a force to the first bale and the second bale in the range of 2,000 to 40,000 kN.

32. A pulp bale production system configured to produce pulp bales from a cellulose containing raw material, the pulp bale production system comprising the pulp bale press according to claim 20.

33. A method of compressing pulp bales in a pulp bale press according to claim 20, the method comprising:
inputting the first bale to be compressed between the base and the movable pressing element;
compressing the first bale by moving the movable pressing element towards the base using the first plurality of hydraulic cylinders and the second plurality of hydraulic cylinders;
when the movable pressing element has moved to a first position in which the top and the movable pressing element are sufficiently distanced to receive the second pulp bale, inputting the second bale to be compressed between the movable pressing element and the top; and
compressing the second bale by moving the movable pressing element towards the top using the first plurality of hydraulic cylinders and the second plurality of hydraulic cylinders.

34. The method according to claim 33, wherein:
the base comprises a first pressing surface,
the movable pressing element comprises a second pressing surface facing the first pressing surface and a third pressing surface facing the top,
the top comprises a fourth pressing surface facing the third pressing surface,
the pulp bale press is configured to receive the first bale to be compressed between the first pressing surface and the second pressing surface, compress the first bale by movement of the movable pressing element towards the base, receive the second bale to be compressed between the third pressing surface and the fourth pressing surface, and compress the second bale by movement of the movable pressing element towards the top,
the inputting the first bale comprises inputting the first bale between the first pressing surface and the second pressing surface, and
the inputting the second bale comprises, when the movable pressing element has moved to a first position in which the third pressing surface and the fourth pressing surface are sufficiently distanced to receive a second pulp bale, inputting the second bale to be compressed onto the third pressing surface.

35. The method of pulp bale pressing according to claim 33, wherein compressing the first bale by moving of the movable pressing element towards the base comprises:
when the movable pressing element is distanced from the first bale, switching a first number of hydraulic cylinders of the first and second pluralities of hydraulic cylinders into a free moving state, wherein the first number of hydraulic cylinders is smaller than a total number of hydraulic cylinders of the first and second pluralities hydraulic cylinders, wherein a first remainder of hydraulic cylinders of the first and second pluralities of hydraulic cylinders is actuated to move the movable pressing element;
moving the movable pressing element towards the base to a first pressing position with respect to the first bale;
switching the number of hydraulic cylinders from the free moving state to an actuated state; and
compressing the first bale by moving the movable pressing element towards the base using all hydraulic cylinders of the first and second pluralities of hydraulic cylinders.

36. The method of pulp bale pressing according to claim 33, wherein compressing the second bale by moving of the movable pressing element towards the top comprises:
when the top is distanced from the second bale, switching a second number of hydraulic cylinders of the first and second pluralities of hydraulic cylinders into a free moving state, wherein the second number of hydraulic cylinders is smaller than a total number of hydraulic cylinders of the first and second pluralities of hydraulic cylinders, wherein a second remainder of hydraulic cylinders of the first and second pluralities of hydraulic cylinders is actuated to move the movable pressing element;
moving the movable pressing element towards the top to a second pressing position with respect to the second bale;
switching the second number of hydraulic cylinders from the free moving state to an actuated state; and
compressing the second bale by moving the movable pressing element towards the top using all hydraulic cylinders of the first and second pluralities of hydraulic cylinders.

37. The method of pulp bale pressing according to claim 35, wherein:
the first pressing position is reached when a force is to be applied to the first bale that is larger than a total force that the remainder of hydraulic cylinders are configured to apply; and/or
the second pressing position is reached when a force is to be applied to the second bale that is larger than a total force that the remainder of hydraulic cylinders are configured to apply.

38. The method of pulp bale pressing according to claim 35, wherein the first number of hydraulic cylinders is equal to the second number of hydraulic cylinders, wherein the first remainder of hydraulic cylinders is equal to the second remainder of hydraulic cylinders.
